(19) United States
(12) Patent Application Publication
(10) Pub. No.: US 2026/0008352 A1
(43) Pub. Date: Jan. 8, 2026

(54) REGENERATIVE BRAKING CONTROL DEVICE AND METHOD FOR ECO-FRIENDLY VEHICLE

(71) Applicants: HYUNDAI MOTOR COMPANY, SEOUL (KR); KIA CORPORATION, SEOUL (KR)

(72) Inventors: Jae Ho Jang, Hwaseong-si (KR); Sang Dong Lee, Hwaseong-si (KR)

(73) Assignees: HYUNDAI MOTOR COMPANY, SEOUL (KR); KIA CORPORATION, SEOUL (KR)

(21) Appl. No.: 18/944,899

(22) Filed: Nov. 12, 2024

(30) Foreign Application Priority Data
Jul. 8, 2024 (KR) 10-2024-0089354

(51) Int. Cl. B60L 7/26; B60L 1/02

(52) U.S. Cl. CPC B60L 7/26; B60L 1/02; B60L 2240/10; B60L 2240/54; B60L 2240/642; B60L 2250/26

(57) ABSTRACT

A regenerative braking control device for an eco-friendly vehicle includes a memory storing computer-readable instructions, and one or more processors configured to access the memory and execute the instructions, the instructions comprise determining whether the eco-friendly vehicle is in a regenerative braking prohibition mode based on a state of charge (SOC) of a high-voltage battery, while a brake pedal sensor (BPS) signal is input, determining whether a performance of a brake pad has deteriorated when the eco-friendly vehicle is in the regenerative braking prohibition mode, and performing regenerative braking, while simultaneously controlling one of a discharge from the high-voltage battery to a low-voltage battery or am operation of an auxiliary load by the high-voltage battery according to an SOC of the low-voltage battery, when it is determined that the performance of the brake pad has deteriorated.

### CROSS REFERENCE TO RELATED APPLICATIONS

This application claims benefit of priority to Korean Patent Application No. 10-2024-0089354 filed on Jul. 8, 2024 in the Korean Intellectual Property Office, the disclosure of which is incorporated herein by reference in its entirety.

### BACKGROUND

### 1. Field

The present disclosure relates to a regenerative braking control device and method for an eco-friendly vehicle.

### 2. Description of Related Art

Eco-friendly vehicles, such as hybrid vehicles and electric vehicles, may drive and charge batteries using a motor, thereby achieving effects, such as improved fuel efficiency and reduced exhaust emission.

These eco-friendly vehicles include a regenerative braking mode in which braking and inertial energy of the vehicles is recovered through power generation from motors during braking or driving by inertia and charged to the batteries.

In the regenerative braking mode, the regenerative braking amount may be generated when driving at a constant speed equal to or lower than a certain speed and may be significantly obtained when decelerating.

In addition, brake force of an eco-friendly vehicle is determined by the sum of the regenerative braking amount by the motor and the hydraulic brake amount by a hydraulic braking device, and the regenerative braking amount and the hydraulic brake amount are distributed at a predetermined distribution ratio.

Meanwhile, regenerative braking of an eco-friendly vehicle is not unconditionally allowed when braking or power generation is required. That is, regenerative braking of an eco-friendly vehicle is allowed only when a battery is available to be charged and is not allowed when the battery does not need to be charged.

That is, when a battery SOC is the maximum charge state (e.g., SOC 95% or higher), regenerative braking is no longer necessary to charge the battery and regenerative braking is prohibited in consideration of the battery life.

More specifically, if regenerative braking is allowed to charge the battery when the battery SOC is the maximum charge state, the battery life may be reduced due to battery deterioration (e.g., lithium ion precipitation, etc.) due to battery overcharging. Therefore, to prevent this, a regenerative braking prohibition logic may be executed when the battery SOC is the maximum charge state. Therefore, when the battery SOC is the maximum charge state, the vehicle is braked 100% by hydraulic braking according to the regenerative braking prohibition logic.

In this case, a braking load is concentrated on a disc included in the hydraulic braking device of the vehicle, thereby significantly increasing the temperature of the disc, which may cause fade and vapor lock of a friction material to seriously impact on safety and cause problems, such as deterioration of braking performance and shortening of the life of the disc.

### SUMMARY

An aspect of the present disclosure is to provide a regenerative braking control device and method for an eco-friendly vehicle capable of reducing a braking load concentrated on a disc of a hydraulic braking brake, thereby preventing deterioration of braking performance and extending the life of the disc.

According to an aspect of the present disclosure, a regenerative braking control device for an eco-friendly vehicle includes one or more processors, and a storage medium storing computer-readable instructions, wherein the computer-readable instructions, when executed by the one or more processors, cause the one or more processors to determine whether the eco-friendly vehicle is in a regenerative braking prohibition mode based on a state of charge (SOC) of a high-voltage battery, while a brake pedal sensor (BPS) signal is input, determine whether a performance of a brake pad has deteriorated when the eco-friendly vehicle is in the regenerative braking prohibition mode, and perform regenerative braking, while simultaneously controlling one of a discharge from the high-voltage battery to a low-voltage battery or am operation of an auxiliary load by the high-voltage battery according to an SOC of the low-voltage battery, when it is determined that the performance of the brake pad has deteriorated.

The one or more processors may be configured to reduce a hydraulic brake amount by a regenerative braking amount generated by the regenerative braking.

The one or more processors may be configured to determine that the eco-friendly vehicle is in the regenerative braking prohibition mode when the SOC of the high-voltage battery is equal to or higher than a preset SOC.

The one or more processors may be configured to determine that the performance of the brake pad has deteriorated when an accumulated hydraulic brake amount (AHBA) is equal to or greater than a preset hydraulic brake amount (PHBA) based on a point in time at which the BPS signal is input.

The one or more processors may be configured to control the discharge from the high-voltage battery to the low-voltage battery and simultaneously perform regenerative braking when the SOC of the low-voltage battery is equal to or less than a preset SOC.

The one or more processors may be configured to control the operation of the auxiliary load by the high-voltage battery and simultaneously perform regenerative braking when the SOC of the low-voltage battery exceeds a preset SOC.

The one or more processors may be configured to perform regenerative braking when the SOC of the high-voltage battery is less than a preset SOC.

The one or more processors may be configured to perform braking using only hydraulic brake force when the AHBA is less than the PHBA based on a point in time at which the BPS signal is input.

The one or more processors may operate when the eco-friendly vehicle drives down a hill.

The auxiliary load may include at least one of a rear heating line, a heater, and an air-conditioner.

The one or more processors may be configured to control an operation of the rear heating line among the auxiliary loads as a top priority and selectively control the heater and air-conditioner according to an outside temperature.

According to another aspect of the present disclosure, a regenerative braking control method for an eco-friendly vehicle includes a first operation of determining whether the eco-friendly vehicle is in a regenerative braking prohibition mode based on a state of charge (SOC) of a high-voltage battery, while a brake pedal sensor (BPS) signal is input, a second operation of determining whether a performance of a brake pad has deteriorated when the eco-friendly vehicle is in the regenerative braking prohibition mode, and a third operation of performing regenerative braking, while simultaneously controlling one of a discharge from the high-voltage battery to a low-voltage battery or am operation of an auxiliary load by the high-voltage battery according to an SOC of the low-voltage battery, when it is determined that the performance of the brake pad has deteriorated.

The regenerative braking control method may further include an operation of reducing a hydraulic brake amount by a regenerative braking amount generated by the regenerative braking.

In the first operation, it may be determined that the eco-friendly vehicle is in the regenerative braking prohibition mode when the SOC of the high-voltage battery is equal to or higher than a preset SOC.

In the second operation, it may be determined that the performance of the brake pad has deteriorated when an accumulated hydraulic brake amount (AHBA) is equal to or greater than a preset hydraulic brake amount (PHBA) based on a point in time at which the BPS signal is input.

The third operation may include an operation of controlling the discharge from the high-voltage battery to the low-voltage battery and simultaneously performing regenerative braking, when the SOC of the low-voltage battery is equal to or less than a preset SOC.

The third operation may include an operation of controlling the operation of the auxiliary load by the high-voltage battery and simultaneously performing regenerative braking when the SOC of the low-voltage battery exceeds a preset SOC.

The first operation may further include an operation of performing regenerative braking when the SOC of the high-voltage battery is less than a preset SOC.

The second operation may further include an operation of performing braking using only hydraulic brake force when the AHBA is less than the PHBA based on a point in time at which the BPS signal is input.

The regenerative braking control method of the eco-friendly vehicle may be applied when driving downhill.

### BRIEF DESCRIPTION OF THE FIGURES

The and other aspects, features, and advantages of the present disclosure will be more clearly understood from the following detailed description, taken in conjunction with the accompanying drawings, in which:

FIG. 1 is a drawing illustrating an eco-friendly vehicle including a regenerative braking control device according to an embodiment of the present disclosure;

FIG. 2 is a flowchart illustrating a regenerative braking control method of an eco-friendly vehicle according to an embodiment of the present disclosure; and

FIG. 3 is a block diagram of a computing device that may fully or partially implement a regenerative braking control device according to an embodiment of the present disclosure.

### DETAILED DESCRIPTION

Hereinafter, embodiments of the present disclosure are described with reference to the accompanying drawings. The following description is provided to aid in the comprehensive understanding of methods, devices, and/or systems disclosed in the particularities. However, the following description is merely exemplary and not provided to limit the present disclosure.

In the following description of the present disclosure, a detailed description of known functions and configurations incorporated herein will be omitted when it would render the subject matter of the present disclosure unclear. The terms used in the present specification are defined in consideration of functions used in the present disclosure, and may be changed according to the intent or conventionally used methods of clients, operators, and users. Accordingly, definitions of the terms should be understood on the basis of the entire description of the present specification. Terms used in the following description are merely provided to describe embodiments of the present disclosure and are not intended to be limiting of the inventive concept. As used herein, the singular forms “a,” “an” and “the” are intended to include the plural forms as well, unless the context clearly indicates otherwise. It will be further understood that the terms “comprises” or “has” when used in this specification, specify the presence of stated features, integers, operations, operations, elements, or a portion or combination thereof, but do not preclude the presence or addition of one or more other features, integers, operations, operations, elements, or a portion or combination thereof.

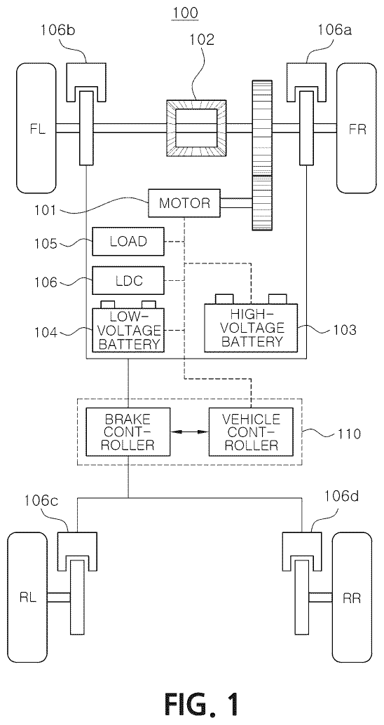

FIG. 1 is a drawing illustrating an eco-friendly vehicle including a regenerative braking control device according to an embodiment of the present disclosure.

As illustrated in FIG. 1, an eco-friendly vehicle 100 includes a motor 101 and a high-voltage battery 103 supplying power to the motor 101. Rotational power generated by the motor 101 by the high-voltage battery 103 is transferred to wheels via a differential gear 102. Calipers 106a, 106b, 106c, and 106d for braking is installed on each wheel, and a hydraulic line transmitting hydraulic pressure may be formed so that braking torque may be generated in each of the calipers 106a, 106b, 106c, and 106d.

In addition, the eco-friendly vehicle 100 may include a brake controller controlling a braking system including a caliper, a disc, and a hydraulic line and may include a vehicle controller controlling a drive motor and regenerative braking. The brake controller may be referred to as an integrated electric booster (IEB) and the vehicle controller may be referred to as a vehicle control unit (VCU). These controllers may be installed individually or integratedly, and in this specification, they are collectively referred to as a regenerative braking control device 110. Therefore, in this specification, the regenerative braking control device 110 is defined as a controller performing control of the entire vehicle including the braking system.

The regenerative braking control device 110 described above may include a processor (e.g., a computer, a microprocessor, a CPU, an ASIC, a logic circuit, etc.) and a memory storing software instructions providing various functions when executed by the processor. Here, the processor and the memory may be implemented as separate semiconductor circuits. Alternatively, the processor and the memory may be implemented as a single integrated semiconductor circuit. There may be one or more processors.

In addition, the eco-friendly vehicle 100 may include a low-voltage battery 104. The low-voltage battery 104 may be a module providing a low voltage of 12 V to 48 V to a low-voltage load, such as a radio.

According to an embodiment of the present disclosure, the low-voltage battery 104 described above may act as a type of load that may be charged and discharged. That is, in the case of a regenerative braking prohibition mode due to the maximum charge of the high-voltage battery 103, the energy stored in the high-voltage battery 103 may be discharged to the low-voltage battery 104 (i.e., the low-voltage battery 104 is charged), thereby enabling regenerative braking, and a braking load concentrated on a hydraulic braking disc may be reduced, thereby preventing deterioration of braking performance and extending the life of the disc.

Meanwhile, a low DC-DC converter (LDC) 106 may be a DC-DC converter discharging the energy stored in the high-voltage battery 103 to the low-voltage battery 104.

Also, the load 105 may include at least one of a rear heating line, a heater, and an air-conditioner as an auxiliary load.

Meanwhile, the regenerative braking control device 110 may determine whether the eco-friendly vehicle 100 is in the regenerative braking prohibition mode based on a state of charge (SOC) of the high-voltage battery 103 while a brake pedal sensor (BPS) signal is input.

According to an embodiment of the present disclosure, when the SOC of the high-voltage battery 103 is equal to or higher than a preset SOC, the regenerative braking control device 110 may determine that the eco-friendly vehicle 100 is in the regenerative braking prohibition mode. Here, the preset SOC may be, for example, 95%, but it should be noted that the present disclosure is not limited to such a specific value.

Meanwhile, when the SOC of the high-voltage battery 103 is less than the preset SOC, the regenerative braking control device 110 may perform regenerative braking.

Thereafter, when it is determined that the eco-friendly vehicle 100 is in the regenerative braking prohibition mode, the regenerative braking control device 110 may further determine whether the performance of a brake pad has deteriorated.

According to an embodiment of the present disclosure, if an accumulated hydraulic brake amount (AHBA) is equal to or greater than a predetermined hydraulic brake amount (PHBA) based on a time at which the BPS signal is input, the regenerative braking control device 110 may determine that the performance of the brake pad has deteriorated.

Meanwhile, if the AHBA is less than the PHBA based on the time at which the BPS signal is input, the regenerative braking control device 110 may perform braking using only hydraulic brake force. The PHBA may be appropriately selected according to the needs of those skilled in the art depending on the performance, specifications, etc. of the eco-friendly vehicle, and it should be noted that the present disclosure is not limited to a specific numerical value here.

Meanwhile, if it is determined that the performance of the brake pad has deteriorated, the regenerative braking control device 110 may perform regenerative braking while controlling either the discharge from the high-voltage battery 103 to the low-voltage battery 104 or the operation of the auxiliary load by the high-voltage battery 103 depending on the SOC of the low-voltage battery 104.

Specifically, if the SOC of the low-voltage battery 104 is lower than or equal to the preset SOC, the regenerative braking control device 110 may control the discharge from the high-voltage battery 103 to the low-voltage battery 104 using the LDC 106, while performing regenerative braking.

Meanwhile, if the SOC of the low-voltage battery 104 exceeds the preset SOC, the regenerative braking control device 110 may control the operation of the load 105 by the high-voltage battery 103, while performing regenerative braking.

Meanwhile, the load 105 may include at least one auxiliary load among a rear heating line, a heater, and an air-conditioner, and the regenerative braking control device 110 may control the operation of the rear heating line as a top priority among the auxiliary loads and may selectively control the heater and air-conditioner according to an outside temperature. This is because the rear heating line is a load that the driver does not recognize even if it is operated.

Thereafter, the regenerative braking control device 110 may reduce the hydraulic brake amount by the amount of regenerative braking generated by the regenerative braking.

The regenerative braking control device 110 as described above may operate when the eco-friendly vehicle 100 is driving down a hill.

As described above, according to an embodiment of the present disclosure, when the regenerative braking prohibition mode is in effect due to the maximum charge of the high-voltage battery, the discharge from the high-voltage battery to the low-voltage battery may be controlled, or when it is difficult to store energy in the low-voltage battery, the operation of the auxiliary load may be controlled to reduce a braking load concentrated on the disc of the hydraulic braking brake, thereby preventing deterioration of the braking performance and extending the life of the disc.

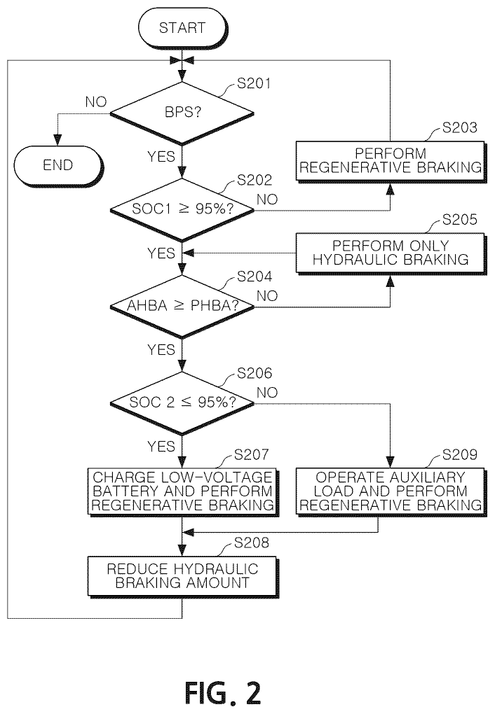

Meanwhile, FIG. 2 is a flowchart illustrating a regenerative braking control method for an eco-friendly vehicle according to an embodiment of the present disclosure.

Hereinafter, a regenerative braking control method for an eco-friendly vehicle according to an embodiment of the present disclosure will be described with reference to FIGS. 1 and 2. However, for the sake of simplification of the disclosure, the same description as that of FIG. 1 is omitted.

Referring to FIGS. 1 and 2, the regenerative braking control method of an eco-friendly vehicle according to an embodiment of the present disclosure may be initiated by an operation in which the regenerative braking control device 110 determines whether a BPS signal is input (S201).

When the BPS signal is input, the regenerative braking control device 110 may determine whether an SOC (SOC1) of the high-voltage battery 103 is equal to or higher than a preset SOC (e.g., 95%) (S202).

If the SOC1 is less than 95% as a determination result in operation S202, the regenerative braking control device 110 may perform regenerative braking (S203).

Meanwhile, if the SOC1 is 95% or greater as a determination result in operation S202, the regenerative braking control device 110 may determine whether an AHBA is greater than or equal to a PHBA based on a point in time at which the BPS signal is input (S204).

If the AHBA is less than the PHBA as a determination result in operation S204, the regenerative braking control device 110 may perform braking by only hydraulic braking (S205).

Meanwhile, if the AHBA is equal to or higher than the PHBA as a determination result in operation S204, it may be determined that the performance of the brake pad has deteriorated, and in this case, the regenerative braking control device 110 may determine whether an SOC (SOC2) of the low-voltage battery 104 is equal to or greater than the preset SOC (e.g., 95%) (S206).

If the SOC2 is less than 95% as a determination result in operation S206, the regenerative braking control device 110 may control the discharge from the high-voltage battery 103 to the low-voltage battery 104 using the LDC 106 and perform regenerative braking at the same time (S207).

Meanwhile, if the SOC2 exceeds 95%, the regenerative braking control device 110 may control the operation of the auxiliary load by the high-voltage battery 103 and perform regenerative braking at the same time (S209).

Here, the load 105 may include at least one auxiliary load among the rear heating line, the heater, and the air-conditioner, and the regenerative braking control device 110 may control the operation of the rear heating line among the auxiliary loads with the top priority, and the heater and air-conditioner may be selectively controlled according to the outside temperature, as described above.

Thereafter, the regenerative braking control device 110 may reduce the hydraulic brake amount by the amount of regenerative braking generated by the regenerative braking (S208).

As described above, according to an embodiment of the present disclosure, in the case of the regenerative braking prohibition mode due to the maximum charge of the high-voltage battery, the discharge from the high-voltage battery to the low-voltage battery may be controlled, or when it is difficult to store energy in the low-voltage battery, the operation of the auxiliary load may be controlled to reduce the braking load concentrated on the disc of the hydraulic braking brake, thereby preventing deterioration of the braking performance and extending the life of the disc.

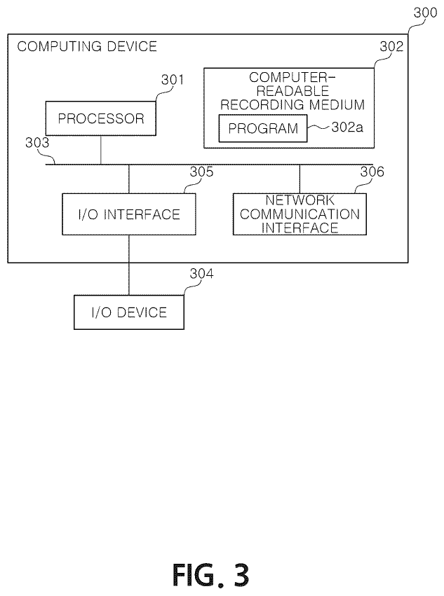

Meanwhile, FIG. 3 is a block diagram of a computing device 300 that may fully or partially implement the regenerative braking control device 110 according to an embodiment of the present disclosure.

As shown in FIG. 3, the computing device 300 includes at least one processor 301, a computer-readable storage medium 302, and a communication bus 303.

The processor 301 may cause the computing device 300 to operate according to the embodiments mentioned above. For example, the processor 301 may execute one or more programs stored in the computer-readable storage medium 302. The one or more programs may include one or more computer-executable instructions, and the computer-executable instructions, when executed by the processor 301, may be configured to cause the computing device 300 to perform operations according to the embodiments.

The computer-readable storage medium 302 is configured to store computer-executable instructions or program code, program data, and/or other suitable forms of information. A program 302a stored on the computer-readable storage medium 302 includes a set of instructions executable by the processor 301. In an embodiment, the computer-readable storage medium 302 may be memory (volatile memory, such as random access memory, nonvolatile memory, or a suitable combination thereof), one or more magnetic disk storage devices, optical disk storage devices, flash memory devices, or any other form of storage medium that may be accessed by the computing device 300 and capable of storing desired information, or a suitable combination thereof.

The communication bus 303 interconnects various other components of the computing device 300, including the processor 301, the computer-readable storage medium 302.

The computing device 300 may also include one or more input/output interfaces 305 providing an interface for one or more input/output (I/O) devices 304, and one or more network communication interfaces 306. The I/O interface 305 and the network communication interface 306 are connected to the communication bus 303. The network may be one of a cellular network, such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), or another cellular network. In addition, the network communication interface 306 may further include one of wireless tag technologies, such as near field communication (NFC).

The I/O device 304 may be connected to other components of the computing device 300 via the I/O interface 305. The I/O devices 304 may include input devices, such as pointing devices (such as a mouse or trackpad), keyboards, touch input devices (such as a touchpad or a touchscreen), voice or sound input devices, various types of sensor devices and/or cameras, and/or output devices, such as display devices, printers, speakers, and/or network cards. The I/O devices 304 may be included within the computing device 300 as a component constituting the computing device 300 or may be connected to the computing device 300 as a separate device distinct from the computing device 300.

According to an embodiment of the present disclosure, in the case of the regenerative braking prohibition mode due to the maximum charge of the high-voltage battery, the discharge from the high-voltage battery to the low-voltage battery may be controlled, or when it is difficult to store energy in the low-voltage battery, the operation of the auxiliary load may be controlled to reduce the braking load concentrated on the disc of the hydraulic braking brake, thereby preventing deterioration of the braking performance, and extending the life of the disc.

Meanwhile, the embodiments of the present disclosure may include a program for performing the methods described in this specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

While the present disclosure has been particularly shown and described with reference to embodiments thereof, a person skilled in the art will understand that the invention is not limited to the disclosed embodiments but may be variously modified within the scope of the present disclosure. Therefore, the scope of the present disclosure should not be limited to the above-described embodiments but should be determined by all changes or modifications derived from the scope of the appended claims and equivalents of the following claims.

1. A regenerative braking control device for an eco-friendly vehicle, the regenerative braking control device comprising:
a memory storing computer-readable instructions; and
one or more processors configured to access the memory and execute the instructions, wherein the instructions comprise:
determining whether the eco-friendly vehicle is in a regenerative braking prohibition mode based on a state of charge (SOC) of a high-voltage battery, while a brake pedal sensor (BPS) signal is input;
determining whether a performance of a brake pad has deteriorated when the eco-friendly vehicle is in the regenerative braking prohibition mode; and
performing regenerative braking, while simultaneously controlling one of a discharge from the high-voltage battery to a low-voltage battery or an operation of an auxiliary load by the high-voltage battery according to an SOC of the low-voltage battery, when it is determined that the performance of the brake pad has deteriorated.

2. The regenerative braking control device of claim 1, wherein the instructions further comprise reducing a hydraulic brake amount by a regenerative braking amount generated by the regenerative braking.

3. The regenerative braking control device of claim 1, wherein the instructions further comprise determining that the eco-friendly vehicle is in the regenerative braking prohibition mode when the SOC of the high-voltage battery is equal to or higher than a preset SOC.

4. The regenerative braking control device of claim 1, wherein the instructions further comprise determining that the performance of the brake pad has deteriorated when an accumulated hydraulic brake amount (AHBA) is equal to or greater than a preset hydraulic brake amount (PHBA) based on a point in time at which the BPS signal is input.

5. The regenerative braking control device of claim 1, wherein the instructions further comprise controlling the discharge from the high-voltage battery to the low-voltage battery and simultaneously performing regenerative braking when the SOC of the low-voltage battery is equal to or less than a preset SOC.

6. The regenerative braking control device of claim 1, wherein the instructions further comprise controlling the operation of the auxiliary load by the high-voltage battery and simultaneously performing regenerative braking when the SOC of the low-voltage battery exceeds a preset SOC.

7. The regenerative braking control device of claim 1, wherein the instructions further comprise performing regenerative braking when the SOC of the high-voltage battery is less than a preset SOC.

8. The regenerative braking control device of claim 1, wherein the instructions further comprise performing braking using only hydraulic brake force when an AHBA is less than a PHBA based on a point in time at which the BPS signal is input.

9. The regenerative braking control device of claim 1, wherein the instructions further comprise operating when the eco-friendly vehicle drives down a hill.

10. The regenerative braking control device of claim 1, wherein the auxiliary load includes at least one of a rear heating line, a heater, and an air-conditioner.

11. The regenerative braking control device of claim 10, wherein the instructions further comprise controlling an operation of the rear heating line among the auxiliary loads as a top priority and controlling the heater and air-conditioner according to an outside temperature.

12. A regenerative braking control method for an eco-friendly vehicle, the regenerative braking control method comprising:
a first operation of determining, by a processor, whether the eco-friendly vehicle is in a regenerative braking prohibition mode based on a state of charge (SOC) of a high-voltage battery, while a brake pedal sensor (BPS) signal is input;
a second operation of determining whether a performance of a brake pad has deteriorated when the eco-friendly vehicle is in the regenerative braking prohibition mode; and
a third operation of performing regenerative braking, while simultaneously controlling one of a discharge from the high-voltage battery to a low-voltage battery or am operation of an auxiliary load by the high-voltage battery according to an SOC of the low-voltage battery, when it is determined that the performance of the brake pad has deteriorated.

13. The regenerative braking control method of claim 12, further comprising a fourth operation of reducing a hydraulic brake amount by a regenerative braking amount generated by the regenerative braking.

14. The regenerative braking control method of claim 12, wherein, in the first operation, it is determined that the eco-friendly vehicle is in the regenerative braking prohibition mode when the SOC of the high-voltage battery is equal to or higher than a preset SOC.

15. The regenerative braking control method of claim 12, wherein, in the second operation, it is determined that the performance of the brake pad has deteriorated when an accumulated hydraulic brake amount (AHBA) is equal to or greater than a preset hydraulic brake amount (PHBA) based on a point in time at which the BPS signal is input.

16. The regenerative braking control method of claim 12, wherein the third operation includes controlling the discharge from the high-voltage battery to the low-voltage battery and simultaneously performing regenerative braking, when the SOC of the low-voltage battery is equal to or less than a preset SOC.

17. The regenerative braking control method of claim 12, wherein the third operation includes controlling the operation of the auxiliary load by the high-voltage battery and simultaneously performing regenerative braking when the SOC of the low-voltage battery exceeds a preset SOC.

18. The regenerative braking control method of claim 12, wherein the first operation further includes performing regenerative braking when the SOC of the high-voltage battery is less than a preset SOC.

19. The regenerative braking control method of claim 12, wherein the second operation further includes performing braking using only hydraulic brake force when an AHBA is less than a PHBA based on a point in time at which the BPS signal is input.

20. The regenerative braking control method of claim 12, wherein the regenerative braking control method of the eco-friendly vehicle is applied when driving downhill.
